(19) United States
(12) Patent Application Publication
(10) Pub. No.: US 2009/0198646 A1
(43) Pub. Date: Aug. 6, 2009

(54) SYSTEMS, METHODS AND COMPUTER PROGRAM PRODUCTS FOR AN ALGEBRAIC APPROACH TO RULE-BASED INFORMATION EXTRACTION

(75) Inventors: Rajasekar Krishnamurthy, Campbell, CA (US); Sriram Raghavan, San Jose, CA (US); Frederick R. Reiss, Sunnyvale, CA (US); Shivakumar Vaithyanathan, San Jose, CA (US); Huaiyu Zhu, Union City, CA (US)

Correspondence Address: CANTOR COLBURN, LLP - IBM ARC DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/023,479

(22) Filed: Jan. 31, 2008

(51) Int. Cl. G06F 17/30

(52) U.S. Cl. 707/3; 707/E17.022

(57) ABSTRACT

Systems, methods and computer program products for an algebraic approach to rule-based information extraction. Exemplary embodiments include a method for rule-based information extraction, the method including specifying an annotator using algebraic operators, wherein each algebraic operator describes annotations identification from text documents.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to information extraction, and particularly to systems, methods and computer program products for an algebraic approach to rule-based information extraction.

2. Description of Background

Search and business intelligence applications are increasingly relying on the wealth of structured information that can be extracted from text. Information of interest to such applications ranges from mentions of entities and relationships (e.g., persons, phone numbers, addresses, etc.) to significantly more complex information such as reviews, opinions, and sentiments. Extracting structured information from unstructured text by finding instances of complex, multilevel patterns in the text can be a difficult task. This structured information serves as an input to application such as search and business intelligence. Some known solutions include grammar-based systems that are based on cascading regular expressions. However, there are drawbacks to grammar-based systems, including: a) extraction performance degrades severely as patterns become more complex; and b) it can be difficult or impossible to express important constructs like “an instance of pattern x contained within an instance of pattern y” and “an instance of pattern x that does not satisfy pattern y”.

In addition, the area of rule-based information extraction (IE) has developed several rule languages and frameworks for building such information extraction programs (called annotators). Since extraction is viewed as a sequential operation over text, such rule languages and their implementations are predominantly based on the theory of grammars and finite-state automata. However, there is a significant issue with the scalability of such approaches, particularly as the complexity of the annotators and the size of the document collections increase. For example, execution times can be high due to the cost associated with the actual evaluation of each grammar rule. Such high CPU cost is a consequence of the fact that, for a grammar rule to be evaluated over a document, potentially every character in that document must be examined. As the number of rules increases, the associated CPU cost per document continues to grow, resulting in a large execution time over the entire collection. One approach to address this scalability problem is that of employing more hardware, distributing the document collection over a large number of processing nodes, and executing the annotators in parallel. However, it is desirable to achieve scalability by improving the efficiency of the processing operations performed by the annotator.

In a current grammar approach, the following example is considered. In the task of extracting, from blogs, informal reviews of live performances by music bands, a grammar approach can be implemented. FIG. 1 illustrates a high-level organization of an annotator that captures the domain knowledge needed to accomplish this task. The two individual modules ReviewInstance and ConcertInstance identify specific snippets of text in a blog. The ReviewInstance module identifies snippets that indicate portions of a concert review—e.g., “show was great”, “liked the opening bands” and “Kurt Ralske played guitar”. Similarly, the ConcertInstance module identifies occurrences of bands or performers—e.g., “performance by the local funk band Saaraba” and “went to the Switchfoot concert at the Roxy”. The output from the ReviewInstance module is fed into the ReviewGroup module to identify contiguous blocks of text containing ReviewInstance snippets. Finally, a ConcertInstance snippet is associated with one or more ReviewGroups to obtain individual BandReviews.

In a traditional rule-based IE system, the annotator described in FIG. 1 would be specified as a series of cascading grammars. To illustrate, a particular rule in the ReviewInstance module that is informally described as follows is considered: A BandMember followed within 30 characters by an Instrument is a ReviewInstance.

A translation of this specification into a cascading grammar yields the results shown in FIG. 2. In exemplary embodiments, the top-level grammar rule R1 expresses the requirement that the pattern BandMember and Instrument appear within 30 characters of each other. Executing R1 invokes rules R2 and R3 which in turn identify BandMember and Instrument instances. For identifying Instrument instances, an exhaustive dictionary of instrument names is used. However, the actual implementation of a dictionary in a grammar-based system is via a regular expression expressed as a union of all the entries in the dictionary as shown in rule R3.

A popular and well-understood standard for cascading grammars is the Common Pattern Specification Language (CPSL). Using such a CPSL-like language a large number of annotators over several diverse data sets can be developed. A significant drawback of the cascading grammar implementations is their enormous execution time. For example, even after extensive performance tuning, the total running time for the annotator shown in FIG. 1 over 4.5 million blog entries is approximately eight hours. Clearly such high execution times are a bottleneck in the widespread use of information extraction techniques.

### SUMMARY OF THE INVENTION

Exemplary embodiments include a method for rule-based information extraction, the method including specifying an annotator using algebraic operators, wherein each algebraic operator describes annotations identification from text documents.

Further exemplary embodiments include a method of annotation plan optimizing in an environment where annotators are expressed as a graph of algebraic operators, the method including identifying subgraphs that exclusively contain relational operators and span extraction operators, applying topological sort to determine order in which to process the subgraphs, optimizing each subgraph independently, selecting the least cost plan for each subgraph and combining the least cost plan for each subgraph into a final plan.

Further exemplary embodiments include a computer program product for annotation plan optimizing in an environment where annotators are expressed as a graph of algebraic operators, the computer program product including instructions for causing a computer to implement a method, including identifying subgraphs that exclusively contain relational operators and span extraction operators, applying topological sort to determine order in which to process the subgraphs, optimizing each subgraph independently, selecting the least cost plan for each subgraph and combining the least cost plan for each subgraph into a final plan.

Additional exemplary embodiments include a computer program product for rule-based information extraction, the computer program product including instructions for causing a computer to implement a method, including specifying an annotator using algebraic operators, wherein each algebraic operator describes annotations identification from text documents.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides an algebraic approach to rule-based information extraction, providing an algebra that includes span and text-specific operators based on building information extraction modules over a wide range of data-sets. In general, an algebra can express annotators that are impossible to describe with a cascading grammar.

By viewing data manipulation procedures as operators in an algebra, database query execution engines are able to consider equivalent but potentially faster execution plans for a given user query. As a result, optimization significantly speeds up annotation running time by reordering operations and eliminating redundant work. The benefits can further include clean semantics and the ability to leverage previous work on optimizing relational algebra queries. In addition, the novel operators and context that are required by IE lend themselves to novel optimizations that are shown to yield impressive improvements to response time when compared to a grammar-based approach.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a high-level organization of an annotator that captures the domain knowledge needed to accomplish a task;

FIG. 2 illustrates a translation of a specification into a cascading grammar in accordance with exemplary embodiments;

FIG. 3 illustrates a block diagram of execution strategies for a rule in accordance with exemplary embodiments;

FIG. 4 illustrates a block diagram of span extraction using a dictionary operator in accordance with exemplary embodiments;

FIG. 5 illustrates a block diagram for an operator graph in accordance with exemplary embodiments;

FIG. 6 illustrates an algebraic expression for a plan in accordance with exemplary embodiments;

FIG. 7 illustrates a block diagram for an expression involving a span-based join predicate p where Restricted Span Evaluation is applicable in accordance with exemplary embodiments;

FIG. 8 illustrates an example of a spurious match for “pipe” that can be produced for the same piece of text that was shown in FIG. 4;

FIG. 9 illustrates a block diagram of a plan enumeration in accordance with exemplary embodiments;

FIG. 10 illustrates a performance comparison chart in accordance with exemplary embodiments;

FIG. 11 illustrates a performance comparison chart as different optimizations are applied in accordance with exemplary embodiments;

FIG. 12 illustrates an example of overlapping annotations in accordance with exemplary embodiments; and

FIG. 13 illustrates a system for an algebraic approach to rule-based information extraction.

The detailed description explains the preferred embodiments of the invention, together with advantages and features, by way of example with reference to the drawings.

### DETAILED DESCRIPTION OF THE INVENTION

In exemplary embodiments, a data model and associated operator algebra for representing the text manipulation tasks that are performed by an annotator are provided. In an exemplary embodiment, the systems and methods described herein focus on a single document for information extraction tasks and thus implement intra-document operations. In exemplary embodiments, the core operations of an annotator involve the generation or examination of contiguous regions of text. Therefore, the fundamental concept in the exemplary algebra is that of a span, a region of text within a document identified by its “begin” and “end” positions. In exemplary embodiments, the user expresses annotators as a graph of algebraic operators, either by directly specifying the graph or by writing a query that the system translates to a graph. An annotation optimizer implements a set of algebraic equivalences and a cost model to analyze many alternate execution plans and chooses the most efficient plan.

In exemplary embodiment, the exemplary systems for an algebraic approach to rule-based information extraction implement an object-relational data model for representing annotations over a given document. Furthermore, set of logical operators can be applied over this model to demonstrate that complex rule-based annotators can be expressed as compositions of these operators.

In exemplary embodiments, the systems and methods implement the exemplary algebra to extract annotations from a single document at a time, the algebra's semantics are defined in terms of the current document being analyzed. In an exemplary implementation, the current document can be modeled as a string called doctext. In exemplary embodiments, each annotator finds regions of doctext that satisfy a set of rules and marks each region with an object called a span. In an exemplary embodiment, a span is an ordered pair <begin,end> that denotes the region of doctext from position begin to position end. In addition, the text of the span's region can be included in the notation. For example, if doctext was the string “Document text”, <9, 12>, “text” would denote the range from characters from positions 9 to 12 of the document.

In exemplary embodiments, the algebra operates over a simple relational data model with three data types: span, tuple, and relation. In the data model, a tuple is an finite sequence of w spans s1, . . . , sw; w is the width of the tuple. A relation is a multiset of tuples, with the constraint that every tuple in the relation must be of the same width. In exemplary embodiments, each operator in the algebra takes zero or more relations as input and produces a single output relation.

In exemplary embodiments, the algebra runs over a local annotation database including the current document and a set of annotation relations that represent pre-computed annotations. As part of the process of loading a document, the system 100 computes a set of useful general-purpose annotations like Sentence, Paragraph, Noun, and Verb and inserts these annotations into the local annotation database. Since a local annotation database only deals with a single document, it generally fits entirely in main memory. In exemplary embodiments, a collection of local annotation databases forms a global annotation database. To annotate all the documents in a global annotation database, the execution framework applies an algebra expression to every local annotation database separately. In exemplary embodiments, execution can proceed as follows:

```
E <-{algebra expression}
For localDB in globalDB do
begin
    1. {Read local DB into main memory}
    2. R<-E(local DB)
    3. {Add R to localDB}
    4. {Write changes to local DB to disk}
end
```

To run multiple annotators in a single pass, step 2 in the above process can be repeated multiple times per document.

In exemplary embodiments, the set of operators in the algebra can be categorized broadly into relational operators, span extraction operators, and span aggregation operators as shown in Table 1. Since the data model is a minimal extension to the relational model, all of the standard relational operators (select, project, join, etc.) apply without any change.

TABLE 1

| Operator Class | Operators |
|---|---|
| Relational Operators | σ, π, ×, ∪, ∩, . . . |
| Span Extraction Operators | εᵣₑ, ε_{d} |
| Span Aggregation Operators | Ω_{O}, Ω_{C}, β |

TABLE 2

| Predicate | Explanation |
|---|---|
| s₁⊂d s₂ | s₁ and s₂ do not overlap, s₁ precedes |
| | s_{2.} and there are at most d characters |
| | between the end of s₁ and the beginning of s₂ |
| s₁ ≅ s₂ | The spans overlap |
| s₁ ⊂ s₂ | s₁ is strictly contained within s₂ |
| s₁ = s₂ | The spans are identical |

In exemplary embodiments, span extraction operators identify segments of text that match a particular input pattern and produce spans corresponding to each such text segment. Since text pattern matching is at the core of almost any information extraction task, these extraction operators perform a significant number of operations for the algebra. The general form of the extraction operators is now described.

In exemplary embodiments, for a function f: Pattern,String→{Span} that maps a string to a set of pattern matches within the string, the corresponding span extraction operator E_{f}(Pattern) returns the maximal set of tuples {(T₁, . . . , Tₙ}, where each Tᵢ consists of a span from f(Pattern, doctext( )).

In exemplary embodiments, the algebra incorporates two kinds of span extraction operators: standard regular expression matcher (εᵣₑ) and dictionary matcher (ε_{d}). Given a regular expression r, εᵣₑ(r) identifies all non-overlapping matches when r is evaluated from left to right over the text represented by s. The output of εᵣₑ(r) is the set of spans corresponding to these matches. Given a dictionary, dict, including a set of words/phrases, the dictionary matcher ε_{d}(dict) produces an output span for each occurrence of some entry in dict within the current document text. A separate dictionary operator is included because most regular expression engines only produce non-overlapping matches whereas the dictionary operator produces all possible matches for each dictionary entry. In addition regular expressions operate at the character level whereas dictionaries are at the level of tokens (i.e., words and phrases). Finally, dictionaries automatically enforce the semantics of word boundaries, i.e., dictionary matches only include complete words and phrases. For example, as shown in FIG. 4, even though “pipe” is an entry in the dictionary, the string “pipe” in the sentence is not a match as it is part of a larger word.

In exemplary embodiments, span aggregation operators take in a set of input spans and produce a set of output spans by performing certain aggregation operations over their entire input. In exemplary embodiments, the input and output of every span aggregation operator is a single-column relation of the form R(a), where R.a is of type Span. In exemplary embodiments, the systems and methods described herein can include: containment consolidation, overlap consolidation, and block.

In exemplary embodiments, consolidate operators are implemented when multiple extraction patterns are used to identify the same concept; two different patterns often produce matches over the same or overlapping pieces of text. To resolve such “duplicate” matches, two kinds of consolidation operations are implemented: containment consolidation and overlap consolidation.

In exemplary embodiments, containment consolidation (Ωc) is used to discard annotation spans that are wholly contained within other annotation spans. Specifically, given a set of input spans, Ωc produces as output only those spans in the input that are not contained within another. In exemplary embodiments, containment consolidation can be expressed using relational operators by applying the correct span predicate. Given a relation R(a), Ωc(R)can be computed as:

R1(x)=Πx(R(a as x)^{x} _{x,y}R(a as y))

Ωc(R)=R(a)−R₁(x as a)

Since containment consolidation is a common operation in several extraction tasks, a first class operator is retained in the algebra.

In exemplary embodiments, overlap consolidation (Ωo) is used to produce new spans by merging overlapping spans. Given a set of spans as input, Ωo produces a set of non-overlapping spans generated by repeatedly merging all possible spans in the input. In exemplary embodiments, an expression for Ωo in terms of relational operators requires a recursive fixed-point computation.

In exemplary embodiments, the block operator (β) identifies a large span of text enclosing a set of input spans such that no two successive spans are more than a specified distance apart. In exemplary embodiments, the systems and methods described herein identify regions of text where input spans occur with enough regularity. For example, as shown in FIG. 5, ReviewGroup is constructed by using the block operator to identify regions of text containing regular occurrences of ReviewInstance. In exemplary embodiments, the block operator takes in two user-defined parameters—a distance constraint and a count constraint. The distance constraint controls the regularity with which input spans must occur within the block and the count constraint specifies a minimum number of such input spans that must be contained within the block.

In exemplary embodiments, the single-column relation R(a), where R.a is of type Span, is the input to a block operator β with distance constraint d and count constraint n. A span (b,e)is produced as output by this block operator if there exists a set of input spans ρ((b,e))⊂R.a such that:
B1. No two spans in ρ((b,e))are overlapping
B2. Each span in ρ((b,e))is contained within (b,e)
B3. |ρ((b,e))|≧n
B4. Any two successive spans in ρ((b,e))are separated by at most d characters
B5. ∃(b,e1)ε ρ((b,e))and (b1,e)ε ρ((b,e))

In exemplary embodiments, the output of the block operator β(n,d,R)is the set of all such spans that satisfy conditions B1..B5. Condition B5 ensures that every span output by the block operator begins and ends with one of the input spans.

In exemplary embodiments, an algebraic approach is applied to information extraction because a principled annotation optimizer similar to database query optimizers is developed. Since the data model and algebra build upon the standard relational model, strategies for generating alternative plans in the relational model known in the art (e.g., pushing down selections, re-ordering joins, etc.) are directly applicable. However, significantly more transformations can be performed by exploiting the semantics of the text-specific operators.

In exemplary embodiments, the systems and methods described herein implement three design guidelines: 1) document-at-a-time processing; 2) CPU-intensive text operations; and 3) Span properties. In keeping with the per-document nature of information extraction, the algebra operates on a single document at a time. As a result, the individual per-document relations that the operators described herein produce and consume are generally quite small and are often completely empty. The core text processing operations of the algebra are the span extraction operators εᵣₑ and ε_{d}. In the absence of any index structures, these operators require the examination of each character or token in a document, resulting in significant CPU cost that often dominates the overall running time of an annotator. A span is merely a special instance of the general mathematical object called an interval. Therefore, spans obey all of the natural properties of interval algebra and these properties yield powerful transformation rules.

Techniques for transforming annotator execution plans are now described in accordance with exemplary embodiments. In exemplary embodiments, it is advantageous is reducing the effect of CPU-intensive text operations by exploiting document-at-a-time processing and span properties.

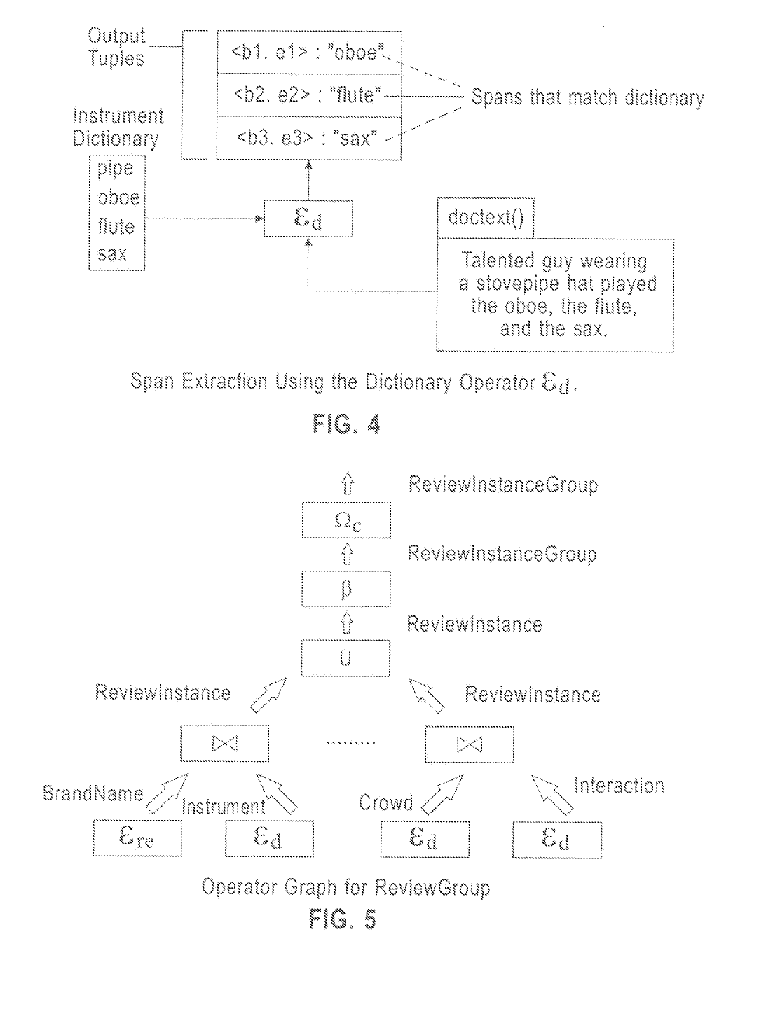

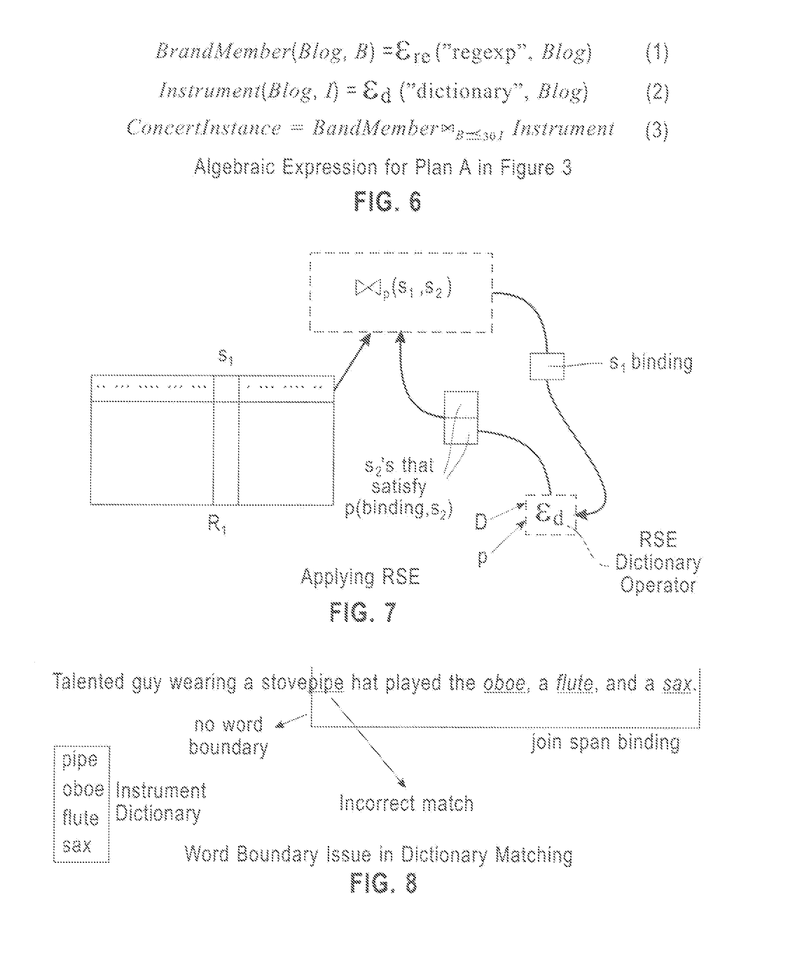

In exemplary embodiments, dictionary matching involves tokenizing the current document's text and looking for all occurrences of the set of words and phrases listed in a specified dictionary. However, dictionaries are also fairly powerful information extraction primitives and therefore used quite often. For example, FIG. 3 shows that ReviewInstance is computed as a union of spans produced by multiple subqueries. In one example of an annotator, there are 39 such subqueries with a total of 69 instances of ε_{d} involving 33 distinct dictionaries. When documents are tokenized at the very beginning of the processing pipeline, an entire pass over these tokens for each ε_{d} operator requires thousands of probes into the dictionary data structures in exemplary embodiments shared dictionary matching (SDM) is implemented, in which each dictionary is evaluated exactly once and the matches are used repeatedly as required. To implement SDM, two physical operators are implemented: 1)DictEval that produces a set of matching spans given a dictionary and a tokenized document; and 2) a Tee operator that duplicates its input stream so that it can be fed into more than one operator further in the processing pipeline. The above version of SDM is effective in avoiding redundant computation when the same dictionary is used as part of multiple extraction patterns (e.g., the Instrument dictionary is used 9 times). However, each distinct dictionary still required one complete pass over the tokens. Therefore, SDM is extended to use: 1) a MultiDictEval operator that simultaneously produces matches for multiple dictionaries using a single scan over the tokens; and 2) a modified version of the Tee operator that can forward a different set of dictionary matches over each of its output streams. For example, the implementation of SDM in a band review annotator significantly improved document throughput as further discussed below.

In exemplary embodiments, conditional evaluation (CE) avoids evaluating an entire subquery over a particular document if it is possible to infer that that document is not going to yield any output annotations. For instance, consider the last step in the BandReview annotator in which ConcertInstance and ReviewBlock are joined together. If the subquery corresponding to ConcertInstance is evaluated first on each document, the evaluation of BandReview can be avoided on documents in which there are no instances of the former. In exemplary embodiments, the entire computation proceeds one document at a time, providing a natural granularity at which to implement such conditional evaluation. The symmetric transformation of evaluating ReviewBlock and conditionally evaluating ConcertInstance is also possible.

In exemplary embodiments, both SDM and CE attempt to either reduce or eliminate work at the document level. In contrast, restricted span extraction (RSE) operates at the sub-document level. In exemplary embodiments, RSE restricts the evaluation of the expensive span extraction operators to some carefully chosen region(s) of text (as opposed to the entire document).

To illustrate this approach, Plan A from FIG. 3 is revisited, expressed in the algebra as indicated in FIG. 6. The join condition in Equation 3 involves a span predicate to enforce the requirement that Instrument must begin within 30 characters of the end of BandMember. Consider a particular BandMember instance b with a span (10, 20). As per the join condition, for an Instrument span to join with b, it must begin somewhere in the range (21, 51). If the maximum length of any entry in the Instrument dictionary is 15 characters, then any Instrument instance that may potentially join with b can be identified by running the dictionary extractor in Equation 2 only over the span (21, 66). Thus, by examining only a portion of the document, the potential Instrument instances that join with b can be computed.

In exemplary embodiments, RSE optimization is a generalization of the technique illustrated by the above example. RSE is applicable for expressions, such as the one shown in FIG. 7, involving a span-based join predicate p with one of the inputs to p computed using the dictionary operator. Similar expressions involving εᵣₑ instead of ε_{d} are also amenable to RSE.

In exemplary embodiments, the systems and methods described herein implement extraction operators that accept bindings for all but one of the unbound variables in a given join predicate p. The RSE extraction operators compute the pattern matches that satisfy p for a given set of bindings, and they do so without examining the entire document. The RSE implementation supports bindings for all the predicates listed in Table 2.

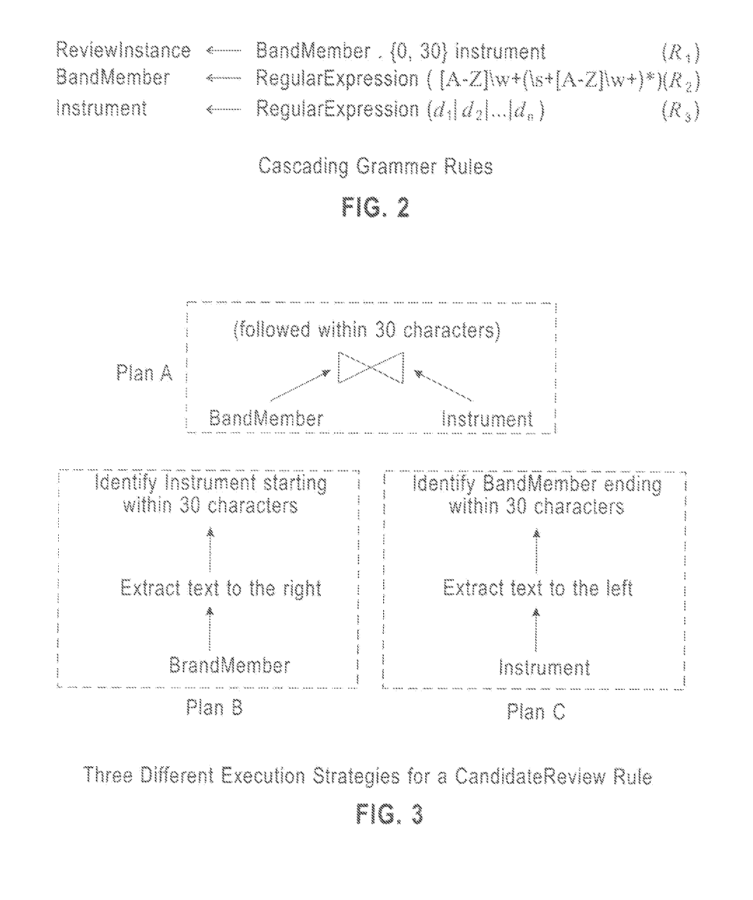

As described herein, dictionary matches enforce word boundaries, i.e., only match complete words or phrases. When restricting the execution of the dictionary extractor to a particular window of text, it is possible that spurious matches are returned at the two end-points of the window. FIG. 8 illustrates a spurious match for “pipe” that can be produced for the same piece of text that was shown in FIG. 2. As such, one extra character can be examined at each end of the span to check for word boundaries. Thus, for the earlier example, the correct join span binding is (20, 66).

In exemplary embodiments, the design of an RSE regular expression extractor takes into account the left-to-right matching semantics of the regular expression operator. Regular expression matches are evaluated in left-to-right order over the entire document. By evaluating a regular expression over an arbitrary window within this text, it may not be possible to precisely compute the set of matches in this window that would have been produced by evaluating over the entire document. Therefore, whenever εᵣₑ is involved, using join span bindings is adopted to only compute the end-offset and always evaluating the regular expression from the very beginning of the document.

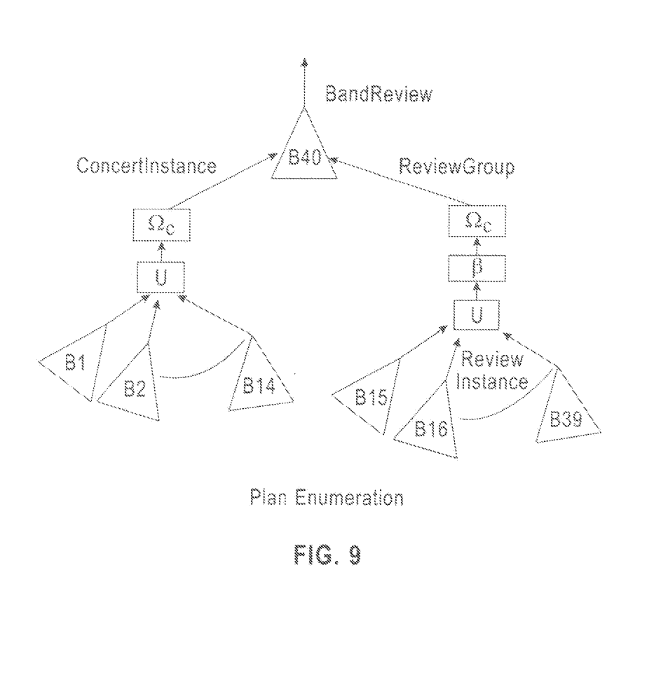

A high-level design of an annotation plan optimizer based on the algebra and optimization is now discussed. Given an operator graph for an annotator in terms of the algebra, the first step is to identify subgraphs that exclusively contain the operators σ, π, ×, ε_{d}, and εᵣₑ (i.e., a Select-Project-Join (SPJ) block extended to include the span extraction operators). In the case of the band review annotator, there are 40 such subgraphs as shown in FIG. 9. Each subgraph is optimized independently, but first a topological sort is applied to determine the order in which to process the subgraphs. The sort order ensures that the cost estimates for a given subgraph's inputs are computed before the subgraph is optimized.

Within each subgraph, a space of possible plans is independently enumerated by: 1) all possible join orders including ones that involve cross-products; 2) standard transformations such as pushing down selections and projections to the extent possible, and 3) additional plans generated by the application of the CE and RSE techniques as described herein.

In exemplary embodiments, each subgraph would be treated independently; the least cost plan would be picked for each, and combined to produce the final plan. However, with the SDM optimization, the cost of evaluating dictionaries is now amortized across subgraphs and must be carefully accounted for. In exemplary embodiments, sharing of dictionary computations is possible only between dictionary operators that are completely evaluated over a document, not when an optimization such as RSE has been applied to restrict the evaluation to a smaller span. In addition, the cost of executing dictionary matches can include two parts: a certain fixed cost associated with tokenization and a variable cost associated with the actual matches produced by each operator. Given these considerations, an approach similar to the one used to handle interesting orders is adopted. For each subgraph B, two optimal plans along with their associated costs are computed: 1) A plan under the assumption that at least one dictionary is evaluated over the entire document, thus enabling amortization of the tokenization cost; and 2) Another plan under the assumption that no dictionary is evaluated over the entire document. Once this pair of plans has been computed, a global pass over all the blocks is used to pick one of the two plans for each block and build the overall execution plan.

### Experiments

The goal of the experimental study is two-fold: 1) validate the performance benefits obtained by using an algebraic approach to information extraction; and (2) understand and contrast the different optimization techniques as discussed herein.

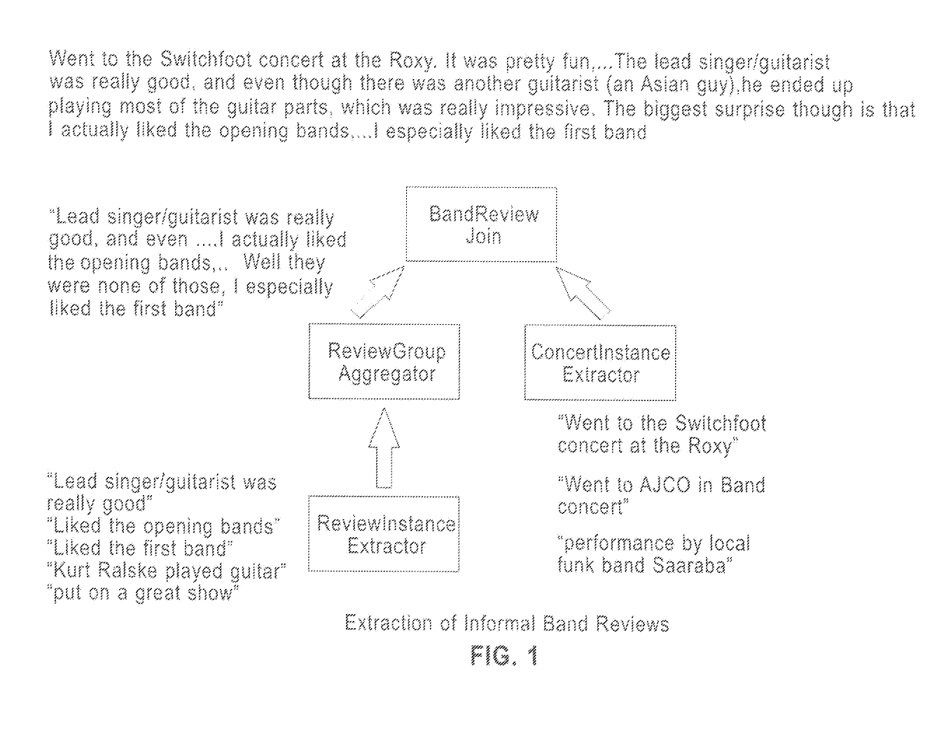

The document corpus used in the experiments is a collection of 4.5 million web logs (5.1 GB of data) crawled from http://www.blogspot.com. Two annotators that identify informal reviews from these blogs (a) BandReview as shown in FIG. 1 and (b) RestaurantReview, which identifies informal reviews of restaurants. Note that even though the two annotators are similar in spirit they have very different operator-graphs. All the experiments were run single-threaded on an IBM xSeries server with two 3.6 GHz Intel Xeon CPUs.

The first set of experiments compare the performance times between the grammar-based implementation and an embodiment of the algebraic approach to rule-based information extraction as described herein. The following implementations are executed: 1) GRAMMAR: A hand-optimized grammar-based implementation that has been tuned separately for both BandReview and RestaurantReview; 2) ALGEBRA_{Baseline}: Baseline for the algebraic approach obtained by directly implementing the plan from GRAMMAR into the operator algebra; and 3) ALGEBRA_{Optimized}: Plan obtained by applying the optimization algorithm presented herein over ALGEBRA_{Baseline}.

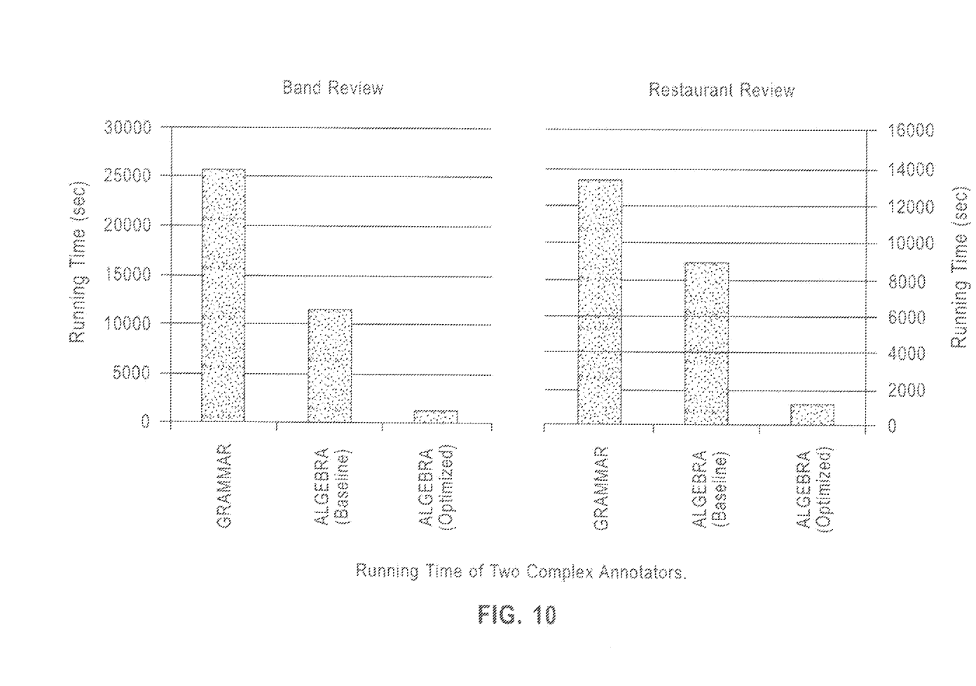

The execution times for BandReview and RestaurantReview are shown in FIG. 10 from the following observations are made: 1) There is a two-fold improvement simply in translating an optimized grammar-based plan to an algebra-based plan; 2) Applying the transformations discussed in Section 3.4 results in an order of magnitude improvement over ALGEBRA_{Baseline}.

Despite the fact that ALGEBRA_{Baseline} is a direct implementation of GRAMMAR there is still a significant improvement in running time, which is explained by the fact that every rule in a cascading grammar is evaluated over the complete text of the document. On the other hand operations in an algebra work only over the input annotations and consequently the running time depends primarily on the size of the input annotations. The exact same information extraction task (BandReview) which took about eight hours in an optimized grammar-based implementation now runs in just under 30 minutes.

To understand the individual transformations and study their interactions with each other multiple versions of BandReview are run. Each version applies a restricted combination of transformations and seven combinations were executed. Four combinations were obtained directly by applying each transformation, discussed herein, individually. Two more were obtained by combining traditional with each of SDM and RSE and the last one obtained by applying all transformations.

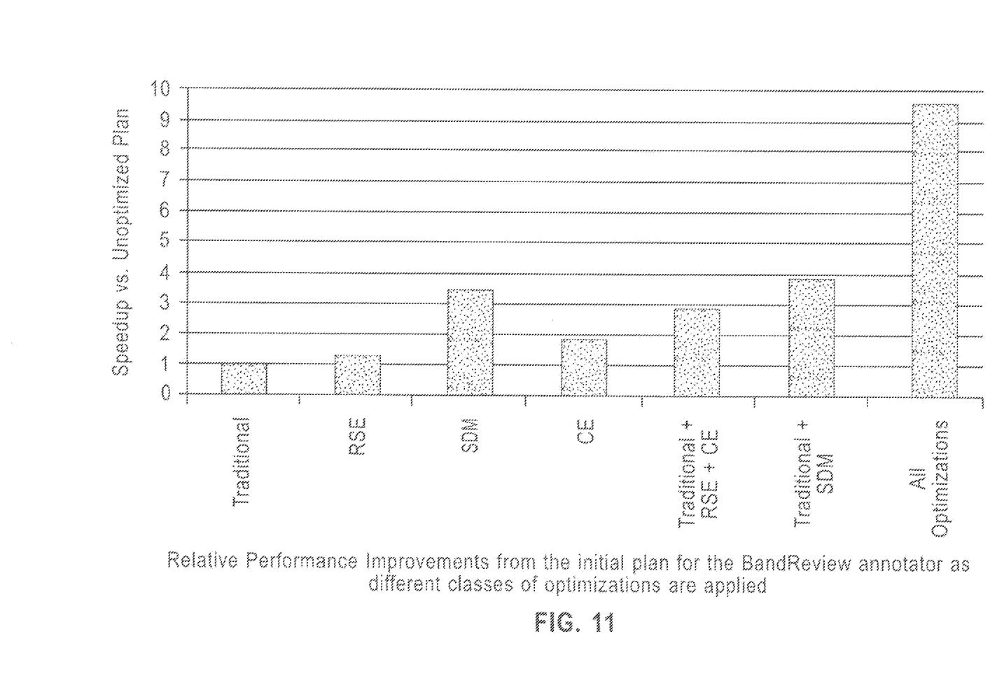

FIG. 11 shows the relative improvement of each combination with respect to ALGEBRA_{Baseline}. Individual transformations provide speedups that are dramatically different from each other. For example, traditional transformations provide no speedup and RSE a small 20%. On the other-hand CE and SDM give significantly greater speedups (a factor of 2 and 3 respectively). The improvement for CE is due to the gains obtained by pruning of an entire subtree (e.g., in FIG. 1 the absence of a ConcertInstance enables the pruning of ReviewGroup and ReviewInstance. SDM shows even greater gains due to the fact that 33 dictionaries are now share computations. In addition, combining a traditional transformation such as “join-reordering” with RSE provides significantly larger speedups than either of them separately, which is due to the fact that “join reordering” enables a larger number of applications of RSE transformations. Applying all four transformations provides a significant improvement over all other combinations.

While the exemplary algebraic approach addresses problems of scalability, the approach has another significant advantage over cascading grammars. To illustrate, the following example t illustrates a common problem in complex information tasks, namely, overlapping annotations.

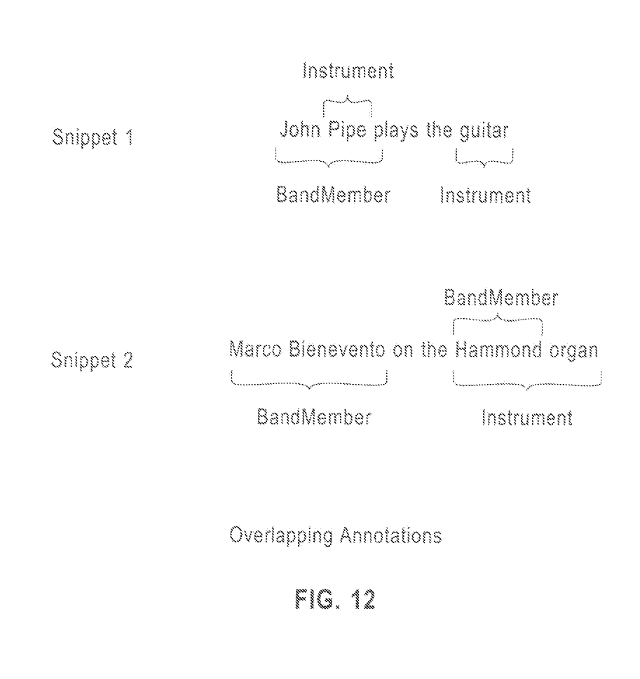

FIG. 12 shows two snippets of text drawn from real world blog entries. Snippet 1 has one instance of BandMember and two instances of Instrument while Snippet 2 has one instance of Instrument and two instance of BandMember. Both snippets have overlapping annotations. The text fragments “Pipe” in Snippet 1 and “Hammond” in Snippet 2 have both been identified as a part of BandMember as well as Instrument.

The annotations overlap because: (a) individual rules are run independently, and (b) rules may make mistakes (in the sense that the author of that rule did not intend to capture a particular text snippet even though the snippet turned out to be a match). In a grammar-based implementation, overlapping annotations must necessarily be disambiguated, i.e., “Pipe” must either be an Instrument or a part of BandMember and a similar choice must be made for “Hammond”. To make these choices, one of several ad hoc disambiguation strategies is employed. Two popular strategies are: (a) retain the annotation that starts earlier (e.g., BandMember for John Pipe), and (b) a priori, impose global tie-breaking rules (e.g., BandMember dominates Instrument). Using (a), the choice in the Snippet 2 is unclear since both annotations start at the beginning of Hammond. Using (b) and assuming BandMember dominates, Snippet 2 is not identified by the cascading grammar in FIG. 2. With the choice of Instrument dominating, Snippet 1 is not identified. In contrast, the exemplary algebraic approach considers the cross-product of BandMember and Instrument instances, thereby eliminating the need for such disambiguation strategies.

To appreciate the true effects of such disambiguation, two experiments were run using the rules from FIG. 2 on 4.5 million blogs. When Instrument was chosen to be the dominant annotation, 6931 instances of ReviewInstance were identified. On the other hand, reversing the dominance resulted in only 5483 instances. Thus, with only three rules arranged into a 2-level cascading grammar, the number of resulting annotations varies dramatically depending on the choice of disambiguation. For extraction tasks with more rules, the situation can only become progressively worse.

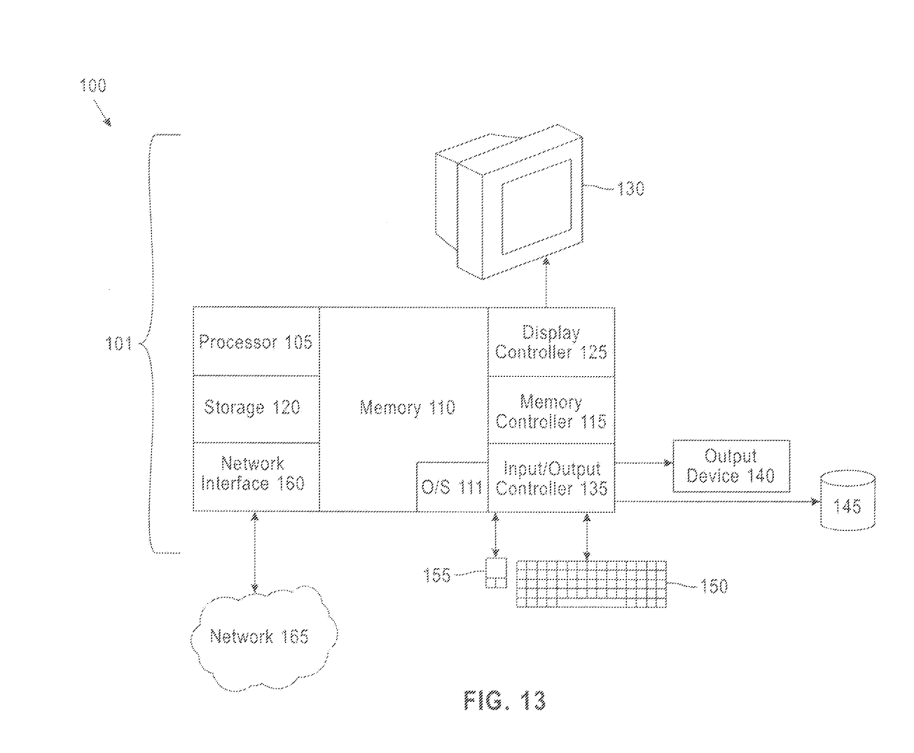

FIG. 13 illustrates a system 100 for an algebraic approach to rule-based information extraction. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 13, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 13, the software in the memory 110 includes the algebraic rule-based information extraction methods described herein in accordance with exemplary embodiments and a suitable operating system (OS) 111. The operating system 111 essentially controls the execution of other computer programs, such the algebraic rule-based information extraction systems and methods described herein, and provides scheduling, input-output control, file and data management, memory management, and communication control and related services.

The algebraic rule-based information extraction methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the OS 111. Furthermore, the algebraic rule-based information extraction methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The algebraic rule-based information extraction methods described herein and the OS 111, in whole or in part, but typically the latter, are read by the processor 105, perhaps buffered within the processor 105, and then executed.

When the systems and methods described herein are implemented in software, as is shown in FIG. 13, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The algebraic rule-based information extraction methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the algebraic rule-based information extraction methods are implemented in hardware, the algebraic rule-based information extraction methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for rule-based information extraction, the method comprising:
specifying an annotator using algebraic operators, wherein each algebraic operator describes annotations identification from text documents.

2. The method as claimed in claim 1 wherein the algebraic operators include span extraction operators configured to identify regions of text that match an input pattern and produce spans corresponding to the matching regions.

3. The method as claimed in claim 1 wherein the algebraic operators include span aggregation operators configured to receive a set of input spans and produce a set of output spans through a set to aggregation operations over the set of input spans.

4. A method of annotation plan optimizing in an environment where annotators are expressed as a graph of algebraic operators, the method comprising:
identifying subgraphs that exclusively contain relational operators and span extraction operators;
applying topological sort to determine order in which to process the subgraphs;
optimizing each subgraph independently;
selecting the least cost plan for each subgraph; and
combining the least cost plan for each subgraph into a final plan.

5. The method as claimed in claim 4 wherein optimizing each subgraph independently comprises for each subgraph enumerating a space of possible plans by join orders.

6. The method as claimed in claim 4 wherein optimizing each subgraph independently comprises:
for each subgraph, enumerating a space of possible plans by standard transformations.

7. The method as claimed in claim 4 wherein optimizing each subgraph independently includes for each subgraph comprises enumerating a space of possible plans by a set of additional plans generated by applying conditional evaluation to each subgraph.

8. The method as claimed in claim 7 further comprising in response to a document under evaluation failing to yield output annotations bypassing evaluation over an entire subquery.

9. The method as claimed in claim 4 wherein optimizing each subgraph independently includes for each subgraph comprises enumerating a space of possible plans by a set of additional plans generated by applying restricted span extraction to each subgraph.

10. The method as claimed in claim 9 wherein restricted span extraction restrict evaluation of span extraction operators to a selected region of text in a document under evaluation.

11. The method as claimed in claim 4 wherein optimizing each subgraph independently includes performing shared dictionary optimization by maintaining the best possible plans with and without shared dictionary optimization.

12. The method as claimed in claim 4 wherein combining the least cost plan includes choosing between the two cases, one where dictionary evaluation is shared across subgraphs and the other were it is not.

13. A computer program product for annotation plan optimizing in an environment where annotators are expressed as a graph of algebraic operators, the computer program product including instructions for causing a computer to implement a method, comprising:
identifying subgraphs that exclusively contain relational operators and span extraction operators;
applying topological sort to determine order in which to process the subgraphs;
optimizing each subgraph independently;
selecting the least cost plan for each subgraph; and
combining the least cost plan for each subgraph into a final plan.

14. The computer program product as claimed in claim 13 wherein optimizing each subgraph independently comprises for each, subgraph enumerating a space of possible plans by join orders.

15. The computer program product as claimed in claim 13 wherein optimizing each subgraph independently includes for each subgraph comprises enumerating a space of possible plans by standard transformations.

16. The computer program product as claimed in claim 13 wherein optimizing each subgraph independently includes for each subgraph comprises enumerating a space of possible plans by a set of additional plans generated by applying conditional evaluation to each subgraph.

17. The computer program product as claimed in claim 13 wherein optimizing each subgraph independently includes for each subgraph comprises enumerating a space of possible plans by a set of additional plans generated by applying restricted span extraction to each subgraph.

18. The computer program product as claimed in claim 13 wherein optimizing each subgraph independently includes for each subgraph identify the least cost plan when dictionaries are shared with other subgraphs and when dictionaries are not shared with other subgraphs.

19. A computer program product for rule-based information extraction, the computer program product including instructions for causing a computer to implement a method, comprising:
specifying an annotator using algebraic operators, wherein each algebraic operator describes annotations identification from text documents.

20. The computer program product as claimed in claim 19 wherein the algebraic operators include at least one of:
span extraction operators configured to identify regions of text that match an input pattern and produce spans corresponding to the matching regions; and
span aggregation operators configured to receive a set of input spans and produce a set of output spans through a set to aggregation operations over the set of input spans.
